(19) United States
(12) Patent Application Publication
(10) Pub. No.: US 2011/0180155 A1
(43) Pub. Date: Jul. 28, 2011

(54) Universal faucet replacement handle

(76) Inventor: Mark David Shantzis, Melbourne Bch., FL (US)

(21) Appl. No.: 12/930,395

(22) Filed: Jan. 6, 2011

Related U.S. Application Data
(60) Provisional application No. 61/336,423, filed on Jan. 22, 2010.

(51) Int. Cl. F16K 31/60

(52) U.S. Cl. 137/315.15

(57) ABSTRACT

A faucet handle assembly is described for replacing a handle on a faucet valve stem that is corroded, making it difficult or impossible to attach a replacement handle by traditional methods of a screw or nut. The assembly includes a hollow vertical body (1, FIG. 1) with a handle means (2) for turning the body clockwise or counterclockwise and a squeezing means (3) and tightening means (4) for clamping the lower end of the vertical body around a corroded valve stem (5) on the top end of the valve stem shaft (6). The assembly could also include a mostly vertical cut (7, FIG. 2) or cuts in the surface of the hollow body to allow the edges of the hollow body to overlap each other when clamped. The edges of the cuts could be beveled or angled (8) to allow for easier overlap. The lower end of the outer surface of said hollow body could have a raised area (9) to “stop” said clamping device from sliding off the end of said hollow body

### CROSS-REFERENCED TO RELATED APPLICATION

This application claims priority to provisional application: No. 61/336,423; Universal Faucet Replacement Handle; Filed Jan. 22, 2010

### BACKGROUND OF THE INVENTION

1. Field of the Invention

The present invention relates to faucet handle assembly and more particularly pertains to a replacement faucet coupling device for securing a faucet handle to a badly oxidized, disfigured or corroded valve stem.

2. Description of the Prior Art

The use of faucet handle coupling devices is known in the prior art. More specifically, faucet handle coupling devices heretofore devised and utilized are known to consist basically of familiar, expected and obvious structural configurations, notwithstanding the myriad of designs encompassed by the crowded prior art which have been developed for the fulfillment of countless objectives and requirements.

Known prior art includes U.S. Pat. No. 4,876,766; U.S. Des. Pat. No. 6,584,649. U.S. Pat. No. 207,940; U.S. Pat. No. 3,129,606; U.S. Pat. No. 5,082,023; U.S. Pat. No. 5,797,422; and U.S. Pat. No. 5,025,826.

While these devices fulfill their respective, particular objectives and requirements, the aforementioned patents do not disclose a replacement faucet handle to be secured to a badly oxidized or corroded valve stem

Faucets generally include a faucet valve stem which is turned to open and close a valve, and a handle assembly mounted on the valve stem to turn the stem. Almost all faucet valve stems have one of two arrangements to hold a metal faucet handle to the stem; 1) a threaded hole in the top of the stem into which a screw can be tightened or, 2) a threaded shaft protruding from the top of the valve stem onto which a nut can be tightened. Many types of replacement handles are available if the screw or nut can be removed and a new handle can be reattached, but there is no easy method for replacing a faucet handle that is badly corroded.

If oxidation or corrosion has advanced enough at the center of the handle to prevent the screw or nut from being removed, it is often necessary to use power tools to grind the corroded valve stem and tool a new screw hole or threaded shaft to accept a screw or nut, or to remove the entire fixture which many times has become fused to the pipe behind the wall. Both methods require skilled labor, are relatively expensive and may cause even more damage.

Nearly all faucet assemblies employ three different types of metal for the handle, the valve stem and the screw or nut. As such, the center of the handle where it connects to the stem and screw (or nut) oxidizes faster than the outside edges of the handle which is gripped by hand to turn. By the time that the outside edges have oxidized enough to be noticed for replacement, the oxidation at the center of the handle has advanced to such a point where the screw or nut is indistinguishable from a molten or corroded blob, hence making it impossible to remove the screw or nut with a screwdriver or wrench.

This invention allows a lay person to inexpensively install a replacement faucet handle on a corroded valve stem in a few minutes with just a screwdriver, circumventing the need for expensive skilled labor and avoiding the possibility of further damage.

Needless to say, if the replacement of the handle is noticed before the center reaches critical oxidation, there are several types of traditional handles that can be attached with a screw or a nut. Universal faucet handle repair kits are available, which enable a handle to be attached to a wide variety of valve stems, but only if a screw or nut can be attached. A faucet handle assembly which could be mounted on almost all corroded faucet valve stems in a reliable connection therewith, without requiring tooling by skilled labor, would be of considerable value.

### SUMMARY OF THE INVENTION

In accordance with one embodiment of this invention, a faucet handle assembly is provided, which can attach to an oxidized or corroded faucet valve stem that otherwise would have to be tooled by skilled labor to prepare the stem for the traditional method of replacement using a screw or a nut to secure the handle to the stem. The assembly includes a hollow body that slips over the corroded valve stem, a clamping method at the lower end of the hollow body to squeeze the outer edges of the lower end securely around the valve stem and a handle at the top of the hollow body to turn the valve stem right or left after the clamp is tightened.

The hollow body can have a vertical cut(s) completely through its surface from the lower end of the body towards the upper end of the body to allow the cut edges of the outer surface to overlap when squeezed by the clamping device.

The cut edges of the outer surface may be beveled or angled as to allow the cut edges to overlap each other more easily when clamped around the corroded valve stem.

The lower end of the outer surface of said hollow body may have a raised area to “stop” said clamping device from sliding off the end of said hollow body.

The novel features of the invention are set forth with particularity in the appended claims.

The invention will be best understood from the following description when read in conjunction with the accompanying drawings.

### BRIEF DESCRIPTION OF THE DRAWINGS

FIG. 1 is a drawn view of a faucet handle assembly of the present invention and a corroded valve stem on which it can be mounted.

FIG. 2 is a perspective side view of the assembly of FIG. 1, without the clamping means.

FIG. 3 is a drawing of a corroded valve stem, with a faucet handle assembly shown spaced apart from the valve stem before being lowered onto the corroded valve stem and of the screwdriver (11) needed to tighten the clamping means.

FIG. 4 is an alternate shaped (flat) faucet handle assembly, shown spaced apart as in FIG. 3.

### DESCRIPTION OF THE PREFERRED EMBODIMENT

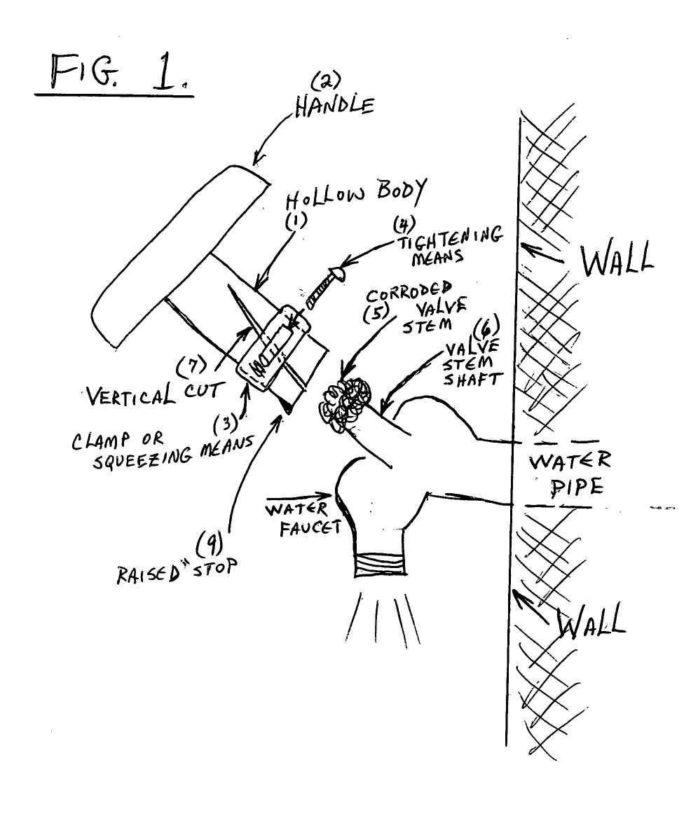

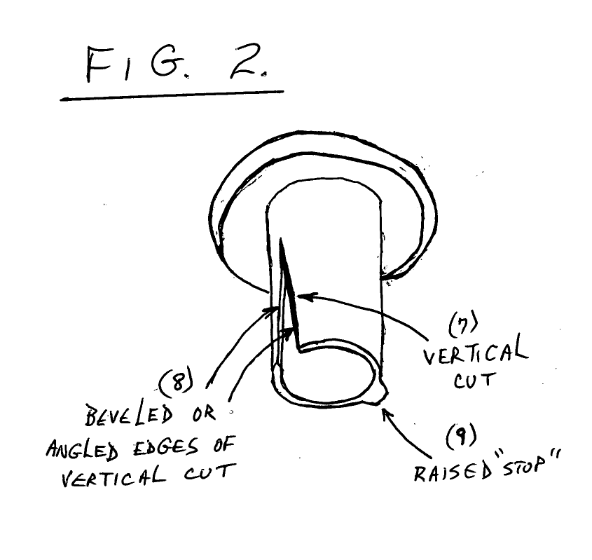

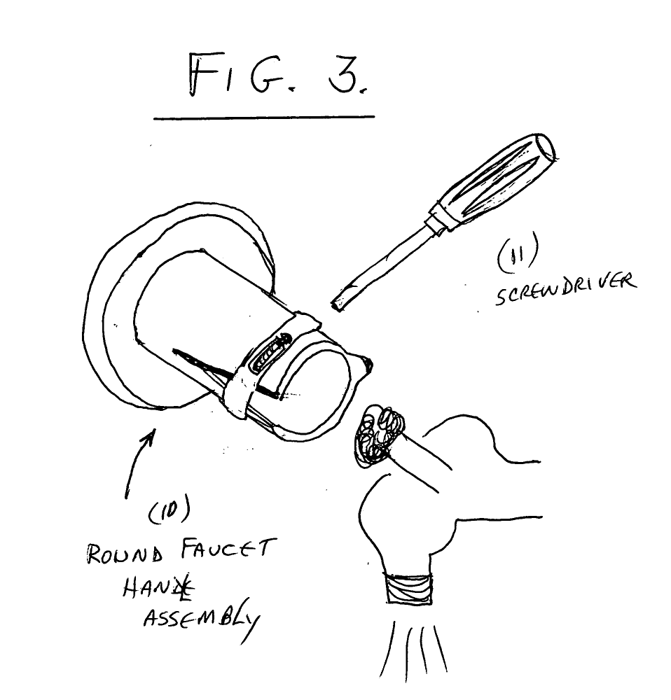

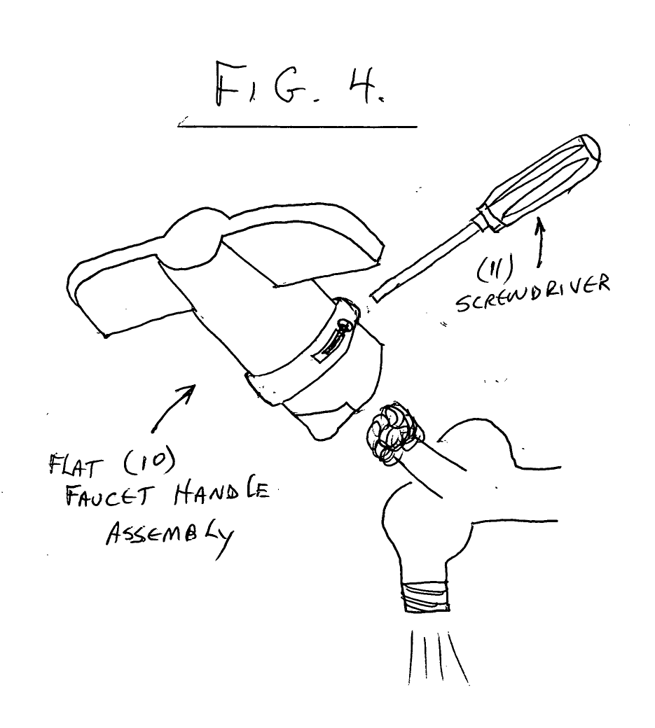

FIG. 3 and FIG. 4 illustrate a faucet handle assembly (10) of rounded and flat handle shapes, respectively, of the present invention. The assembly includes a hollow vertical body (1, FIG. 1) with a handle means (2) for turning the body clockwise or counterclockwise and a squeezing means (3) and tightening means (4) for clamping the lower end of the vertical body around a corroded valve stem (5) on the top end of the valve stem shaft (6). The assembly could also include a mostly vertical cut (7, FIG. 2) or cuts in the surface of the hollow body to allow the edges of the hollow body to overlap each other when clamped. The edges of the cuts could be beveled or angled (8) to allow for easier overlap. The lower end of the outer surface of said hollow body could have a raised area (9) to “stop” said clamping device from sliding off the end of said hollow body. Previously, a replacement handle was required which had a cavity that matched the peripheral surface of the valve stem in shape and size, and which was securely held by the screw or nut. Another sold replacement kit included one handle and a large number of adapters or spuds that all had an outer surface that could fit the handle cavity, and with different spuds having different hole shapes and sizes to fit different valve stems. The present invention can attach to an oxidized or corroded faucet valve stem that otherwise would have to be tooled by skilled labor to prepare the stem for the traditional method of replacement using a screw or a nut to secure the handle to the stem. The present invention allows the replacement handle (10, FIG. 3) a wide variety of commonly encountered corroded valve stems for small valves of the type used for home and commercial water faucets that otherwise would have to be tooled by skilled labor to prepare the stem for the traditional method of replacement using a screw or a nut to secure the handle to the stem. The present invention is used where a screw or nut cannot reasonably be used to attach a replacement handle.

The novel features of the invention are set forth with particularity in the appended claims. The invention will be best understood from the description when read in conjunction with the accompanying drawings. Although particular embodiments of the invention have been described and illustrated herein, it is recognized that modifications and variations may readily occur to those skilled in the art, and consequently, it is intended that the claims be interpreted to cover such modifications and equivalents.

What is claimed is:

1. A faucet handle assembly for attachment to a faucet valve stem that has corroded, making it difficult or impossible to connect a replacement handle using traditional methods and, that must be turned clockwise or counterclockwise to operate the faucet valve, comprising:
a hollow vertical body to slip over the corroded valve stem,
a clamping device for securing the hollow vertical body to the corroded valve stem,
a tightening device for tightening the clamping device
a faucet handle for turning the hollow body which when clamped around the corroded valve stem, turns the valve stem.

2. The assembly described in claim 1 wherein:
said hollow body has a mostly vertical cut or cuts in the outer surface of the body to allow the cut edges of the outer surface to overlap when squeezed by the clamping device;
said cut edges of the outer surface being beveled or angled as to allow the cut edges to overlap each other more easily when clamped around the corroded valve stem.

3. The assembly described in claim 1 wherein:
the lower end of the outer surface of said hollow body has a raised area to stop said clamping device from sliding off the end of said hollow body.
